(19) United States
(12) Patent Application Publication
(10) Pub. No.: US 2024/0198539 A1
(43) Pub. Date: Jun. 20, 2024

(54) TOOL CHANGER

(71) Applicant: Progressive Surface, Inc., Grand Rapids, MI (US)

(72) Inventor: Mitchell Scott Hopkins, Wyoming, MI (US)

(73) Assignee: Progressive Surface, Inc., Grand Rapids, MI (US)

(21) Appl. No.: 18/523,250

(22) Filed: Nov. 29, 2023

Related U.S. Application Data
(60) Provisional application No. 63/433,634, filed on Dec. 19, 2022.

(51) Int. Cl. B25J 15/04

(52) U.S. Cl. CPC B25J 15/0408

(57) ABSTRACT

A tool changer includes a base, a hose coupler that is configured to be mounted to a robot arm and an adapter. Movement of a robot arm may be utilized to selectively couple and decouple the components of the tool changer to each other whereby tool changes can be accomplished without manual operations.

### CROSS-REFERENCE TO RELATED APPLICATION

This application claims the benefit under 35 U.S.C. § 119(e) to U.S. Provisional Patent Application No. 63/433,634, filed Dec. 19, 2022, entitled “TOOL CHANGER,” which is incorporated herein by reference in its entirety.

### BACKGROUND OF THE INVENTION

Various types of automatic tool changers have been developed for use with robots and automated machinery. Automatic tool changers are typically used in relatively clean environments that are not subject to build up of grit or other abrasives.

### BRIEF SUMMARY OF THE INVENTION

An aspect of the present disclosure is a tool changer for robotic systems. The tool changer may include a base having a coupling structure. The coupling structure may comprise a plurality of slots. The slots may open upwardly and may be Z-shaped. The tool changer further includes a hose coupler that is configured to be mounted to a robot arm. The hose coupler includes a coupling structure. The coupling structure of the hose coupler may optionally comprise a plurality of slots. The slots of the tool holder may optionally be L-shaped. The hose coupler may optionally include an internal passageway that is open at opposite ends of the hose coupler whereby the hose coupler can be coupled to a hose, and material (matter) such as solid media and/or fluid (gas and/or liquid) from the hose can pass through an end portion of a hose that is disposed in the passageway of the hose coupler. The tool changer further includes an adapter having a connecting structure that permits a tool to be secured to the adapter. The adapter may also include an internal passageway that is open at opposite ends of the adapter. The adapter optionally includes a first set of pins that are configured to releasably engage the L-shaped slots of the hose coupler to couple the adapter to the hose coupler whereby material (matter) such as solid media and/or gas from the hose coupler flows through the internal passageway of the adapter. The adapter optionally includes a second set of pins that are configured to releasably engage the Z-shaped slots of the base. In use, the adapter can be positioned on the base with the second set of pins engaging the Z-shaped slots, and the hose coupler can be attached to a robot arm whereby the hose coupler can be moved into engagement with the adapter such that the first set of pins of the adapter enter first portions of the L-shaped slots of the hose coupler. The hose coupler can then be rotated such that the first pins of the adapter move into second portions of the L-shaped slots of the hose coupler to attach the adapter to the hose coupler. The tool changer may optionally include a gasket that is compressed as the adapter is attached to the hose coupler to create a seal and lock the adapter into place at the end of the rotation. The robot arm can then disengage the adapter from the base by lifting the adapter to move the second set of pins from end portions of the Z-shaped slots of the base, followed by rotation of the adapter to move the second set of pins in transverse portions of the Z-shaped slots of the base, followed by lifting the adapter to move the second set of pins out of open end portions of the Z-shaped slots of the base.

The Z-shaped slots may be configured such that, when the adapter is not in use, the adapter rests in the bottom of the Z-shaped slots in a repeatable, captured position to allow for robotic engagement. At drop off, the mid section of the “Z” allows the robot to disengage the adapter with an upward motion such that the adapter is pulled off the hose coupler by the base if it held up in any way (e.g. in dusty or gritty applications in which the adapter may become stuck in the hose coupler).

Another aspect of the present disclosure is a tool changer that may be utilized in connection with robotic systems. The tool changer may comprise a base having a first connecting structure. The tool changer may further comprise a hose coupler that may be configured to be mounted to a robot arm. The hose coupler may include a connecting structure. The tool changer may further include an adapter that is configured to have a tool secured thereto. The adapter may include a third connecting structure that may be configured to releasably engage the second connecting structure of the hose coupler to releasably couple the adapter to the hose coupler. The adapter may further include a fourth connecting structure that may be configured to engage the first connecting structure of the base. In use the adapter can be supported by the base with the fourth connecting structure engaging the first connecting structure of the base, and the hose coupler can be moved into engagement with the adapter (e.g. by a robotic arm) such that the third connecting structure of the adapter engages the second connecting structure of the hose coupler. The adapter may be adapted to be coupled to the hose coupler due to movement of the hose coupler relative to the adapter, and the adapter may be decoupled from the base by moving the adapter relative to the base (e.g. by a robotic arm) to disengage the fourth connecting structure from the first connecting structure whereby the adapter can be moved away from the base.

The first connecting structure may optionally comprise one or more slots. The one or more slots may optionally include an upwardly extending portion having an open end.

The one or more slots may optionally include at least one transverse portion that is transverse to the upwardly extending portion. The upwardly extending portion may optionally comprise a first upwardly extending portion. The one or more slots may optionally include a second upwardly extending portion.

The first upwardly extending portion and the second upwardly extending portion are optionally offset horizontally relative to one another. The second upwardly extending portion may optionally extend upwardly from the transverse portion. The first upwardly extending portion, the transverse portion, and the second upwardly extending portion may optionally form a Z-shaped slot.

The second connecting structure may optionally comprise one or more slots. The one or more slots may optionally have an upwardly extending portion having an open end. The one or more slots may optionally include at least one transverse portion that is transverse to the upwardly extending portion. The one or more slots are optionally L-shaped.

The third connecting structure of the adapter optionally comprises a first set of pins that are adapted to releasably engage the second connecting structure of the hose coupler.

The fourth connecting structure of the adapter optionally comprises a second set of pins that are adapted to releasably engage the first connecting structure of the base.

The hose coupler optionally includes an internal passageway that is open at opposite ends of the hose coupler, whereby the hose coupler can be coupled to a hose to permit material such as solid media and fluid from the hose to pass through the internal passageway of the hose coupler.

The adapter optionally includes an internal passageway that is open at opposite ends of the adapter, whereby material such as solid media and fluid from the hose coupler may flow through the internal passageway of the adapter to a nozzle or lance that is mounted to the adapter.

The second connecting structure of the hose coupler may, optionally, be moved into engagement with the third connecting structure of the adapter by initially moving the hose coupler towards the adapter, followed by rotation of the hose coupler relative to the adapter to thereby couple the hose coupler to the adapter.

After coupling the hose coupler to the adapter, the adapter may, optionally, be decoupled from the base by shifting the adapter relative to the base a first time, followed by rotating the adapter relative to the base, followed by shifting the adapter relative to the base a second time.

Initially moving the hose coupler towards the base may optionally include moving the hose coupler downwardly relative to the adapter. Shifting the adapter relative to the base a first time may optionally include moving the adapter upwardly relative to the base. Shifting the adapter relative to the base a second time may optionally include moving the adapter upwardly relative to the base.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially fragmentary exploded isometric view showing a tool changer according to an aspect of the present disclosure;

FIG. 2 is a partially fragmentary view of a tool holder according to an aspect of the present invention wherein an adapter is positioned on a base prior to engagement with a hose coupler;

FIG. 3 is a partially fragmentary view of a tool changer according to an aspect of the present disclosure wherein the adapter is coupled to the hose coupler, and the adapter is decoupled from the base;

FIG. 4 is a front elevational view of a hose coupler;

FIG. 5 is a partially fragmentary enlarged portion of the hose coupler of FIG. 4;

FIG. 6 is a bottom plan view of the hose coupler of FIG. 4;

FIG. 7 is a front elevational view of an adapter according to an aspect of the present disclosure;

FIG. 8 is a bottom plan view of the adapter of FIG. 7;

FIG. 9 is a cross sectional view of the adapter of FIG. 8 taken along the line IX-IX;

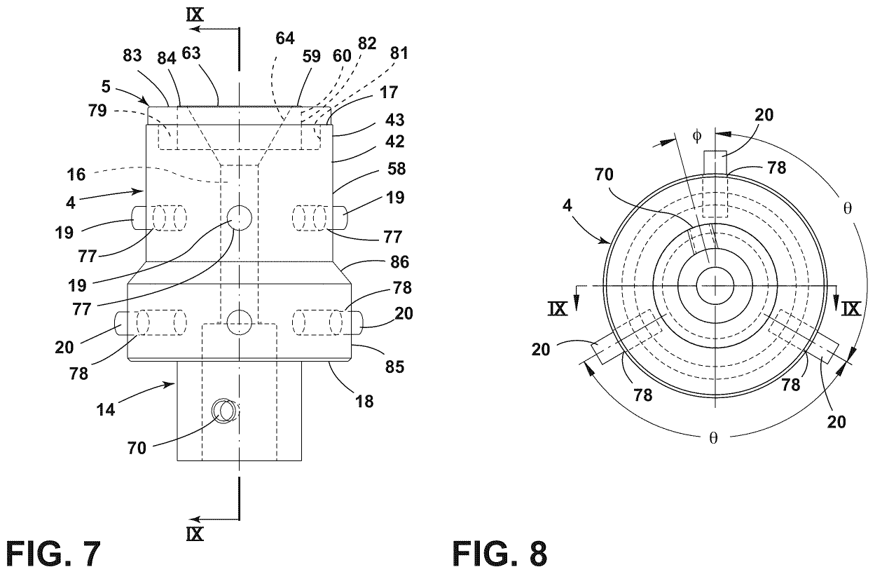

FIG. 7; and

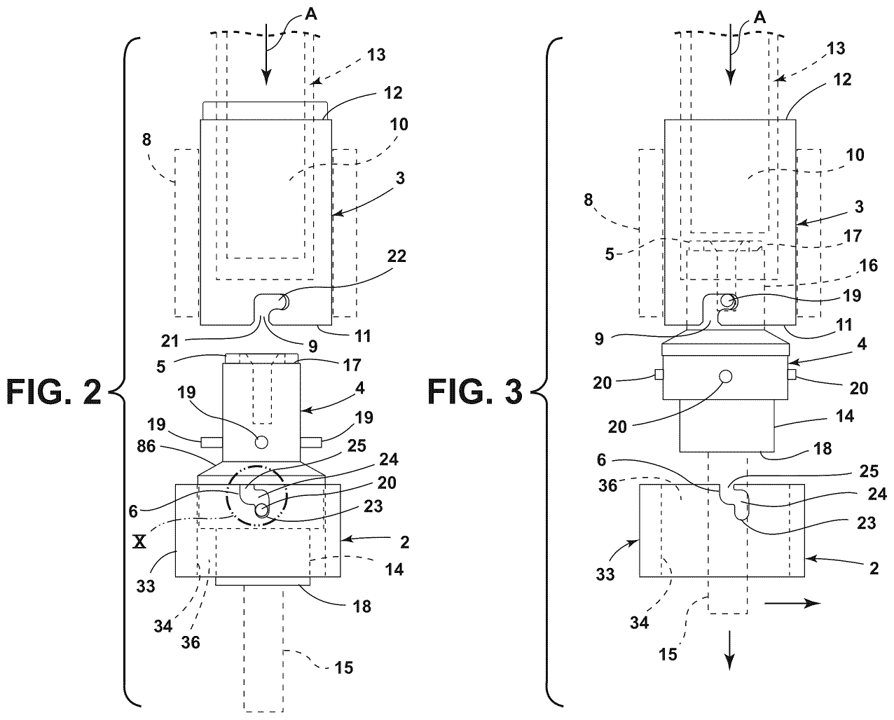

FIG. 10 is a partially fragmentary enlarged view of a portion of the base of FIG. 2.

### DETAILED DESCRIPTION

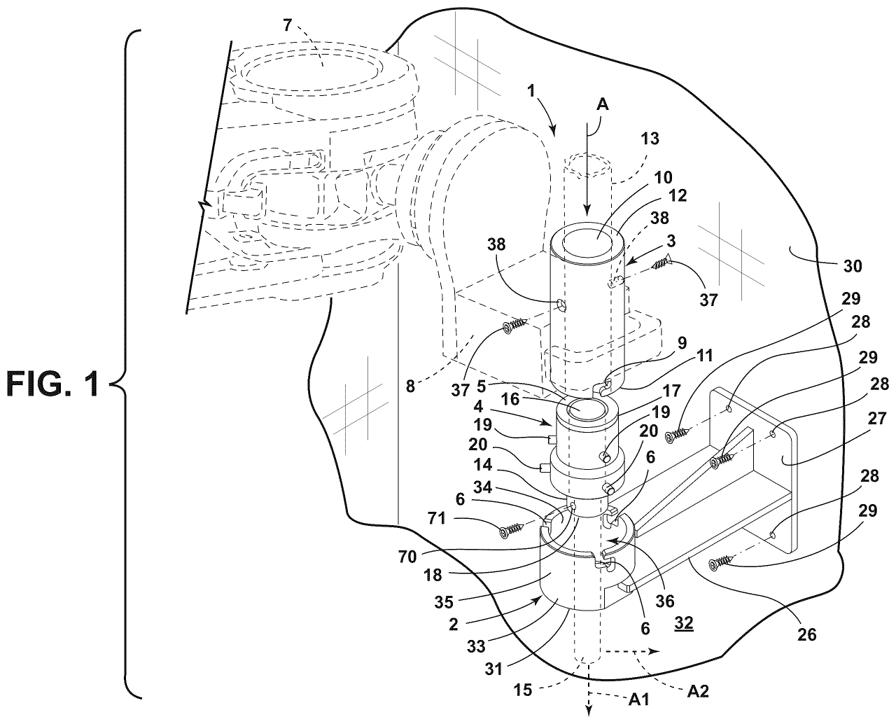

For purposes of description herein the terms “upper,” “lower,” “right,” “left,” “rear,” “front,” “vertical,” “horizontal,” and derivatives thereof shall relate to the disclosure as oriented in FIG. 1. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 1, a tool changer 1 according to an aspect of the present disclosure includes a base 2 that is configured to releasably support an adapter 4. Adapter 4 is configured to be releasably coupled to a hose coupler 3. As discussed in more detail below, hose coupler 3 can be mounted to a movable device having powered actuators. The movable device may comprise a robot arm 7, and robot arm 7 can be moved to selectively couple and decouple hose coupler 3 to/from adapter 4. Robot arm 7 may comprise a commercially available robot arm that may be operably connected to a programmable controller. Arm 7 can also be moved to selectively couple and decouple adapter 4 to/from base 1. Base 2, hose coupler 3, and adapter 4 can be configured such that coupling and decoupling of these components can be accomplished by movement of arm 7 such that no additional powered actuators or manual operations are required. As discussed in more detail below, a resilient gasket 5 forms a seal at the joint interconnecting hose coupler 3 and adapter 4 so that material (matter) such as a slurry (e.g. a mixture of liquid and solid media) or solid media and air (arrow “A”) passing through hose coupler 3 into adapter 4 cannot escape, and resilient gasket 5 also generates an axial force biasing hose coupler 3 away from adapter 4 when resilient gasket 5 is compressed. This axial force biases pins 19 into engagement with seating portions 52 of slots 9 (FIG. 5) such that force is required to rotate hose coupler 3 relative to adapter 4 to move pins 19 in the direction of arrow “P4” (FIG. 5) as required to decouple base coupler 3 from adapter 4. Slots 9 may optionally be L-shaped or any other suitable shape.

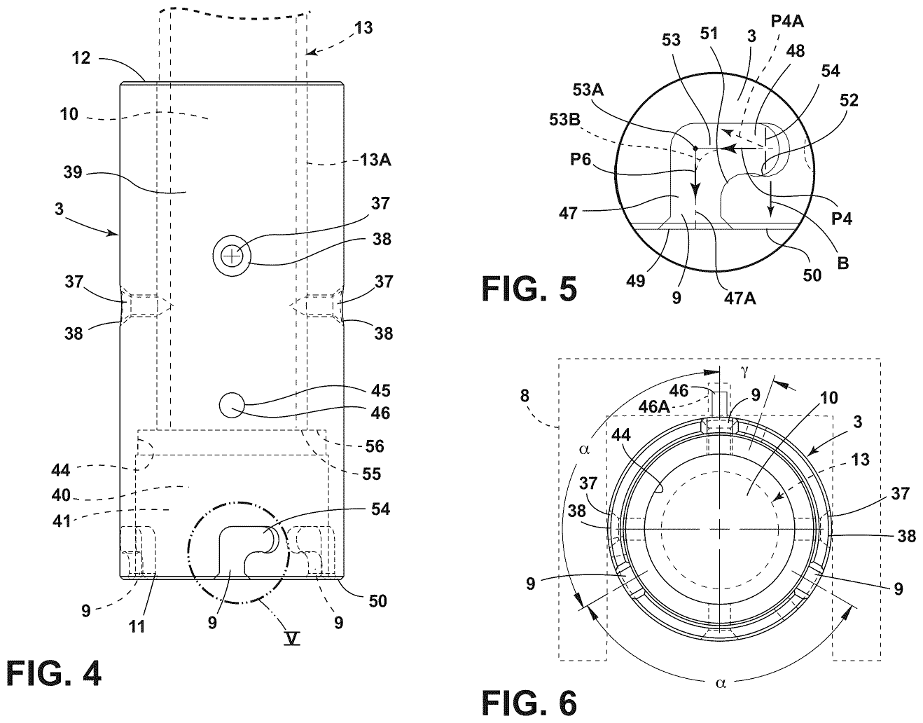

Base 2 includes a first connecting structure which may optionally comprise a plurality of upwardly opening slots 6. Slots 6 may optionally be Z-shaped or any other suitable shape. Hose coupler 3 may be mounted to robot arm 7 utilizing a bracket 8 or other suitable connector. The hose coupler 3 may include a second connecting structure which may optionally comprise a plurality of L-shaped slots 9 (see also FIGS. 4-6). The hose coupler 3 includes an internal passageway 10 that is open at opposite ends 11 and 12 of the hose coupler 3 whereby the hose coupler 3 can be coupled to a hose 13 and matter such as solid media and fluid (see arrow “A” FIGS. 1-3) from the hose 13 can pass through the internal passageway 10 of the hose coupler 3. As shown in FIG. 4, an end 13A of hose 13 may be disposed in internal passageway 10 of hose coupler 3 such that the material or matter A (FIG. 1) flowing through end 13A of hose 13 and passageway 10 of hose coupler 3 does not contact the internal surfaces of passageway 10. This is not, however, required, and passageway 10 of hose coupler 3 could be configured such that the material or matter passing through passageway 10 does contact at least a portion of the surface of passageway 10. As discussed in more detail below, hose 13 may optionally comprise a blast hose that is operably connected to a blasting device (not shown) that supplies fluid (liquid and/or gas) and/or solid media (e.g. abrasive grit, polymer beads or particles, or shot) to provide for blasting operations and the like. It will be understood that virtually any material or matter in any combination or form may flow through hose 13, hose coupler 3, adapter 4, and a tool 15.

The tool changer further includes an adapter 4 having a connecting arrangement or structure 14 that permits a tool 15 to be secured (mounted) to the adapter 4. As discussed in more detail below, the tool 15 may optionally comprise a nozzle or lance of a known type that directs the solid media and air towards a surface to be treated. The adapter 4 may further include an internal passageway 16 that is open at opposite ends 17 and 18 of the adapter 4. The adapter 4 may also include a third connecting structure. The third connecting structure may optionally comprise a first (upper) set of pins 19 that are configured to releasably engage the second connecting structure (e.g. L-shaped slots 9) of the hose coupler 3 to thereby releasably couple the adapter 4 to the hose coupler 3 whereby solid media and gas “A” from the hose coupler 3 flow through the internal passageway 16 of the adapter 4 to the nozzle/lance/tool 15. The adapter 4 may further include a fourth connecting structure. The fourth connecting structure may optionally comprise a second (lower) set of pins 20 that are configured to releasably engage the first connecting structure (e.g. Z-shaped slots 6) of the base 2.

In use, the adapter 4 can be positioned on the base 2 with the second set of pins 20 engaging the Z-shaped slots 6 (FIG. 2). Pins 20 may engage an end portion 23 of Z-shaped slots 6 (see also FIG. 10). End portion 23 of Z-shaped slots 6 may have a width “W1” (FIG. 10) that is slightly larger than a diameter of pins 20, and the location of end surface 23A of Z-shaped slots may be precisely located such that adapter 4 is accurately positioned relative to base 2 when adapter 4 is positioned in base 2. In order to remove adapter 4 from base 2, in use the hose coupler 3 can be attached to robot arm 7 whereby the hose coupler 3 can be moved into engagement with the adapter 4 such that the first pins 19 of the adapter 4 enter first portions 21 (FIG. 2) of the L-shaped slots 9 of the hose coupler 3. Because the adapter 4 is precisely located on base 2, the robot arm 7 can be moved to the correct position to cause first pins 19 to engage L-shaped slots 9. This may be followed by rotation of the hose coupler 3 such that the first set of pins 19 of the adapter 4 move into second (transverse) portions 22 of the L-shaped slots 9 of the hose coupler 3 to thereby attach the adapter 4 to the hose coupler 3. The robot arm 7 can then disengage (decouple) the adapter 4 from the base 2 by lifting adapter 4 to move the second pins 20 from end portions 23 of the Z-shaped slots 6 of the base 2 (e.g. arrow “P1,” FIG. 10), followed by rotation of the adapter 4 to move the second pins 20 in transverse portions 24 of the Z-shaped slots 6 of the base 2 (arrow “P2,” FIG. 10), followed by lifting the adapter 4 to move the second pins 20 (arrow “P3,” FIG. 10) out of open end portions 25 of the Z-shaped slots 6 of the base 2. As discussed in more detail below, the arm 7 can position an adapter 4 and a nozzle or lance that does not need to be used on a base 2 and decouple hose coupler 3 from the adapter 4 by reversing the movements just described whereby an adapter 4 and tool 15 is stored/supported on base 2 while a different adapter 4 and tool 15 is used by the robot for a different operation (e.g. a different blasting operation).

Referring again to FIG. 1, base 2 may comprise a support structure 26 including a base plate 27 having a plurality of openings 28 that may receive threaded fasteners such as screws 29 to secure the base 2 to a surface 30 (e.g. a wall) of a blast work area 32. The base 2 further includes an end portion 33 that may include a sidewall 31 having a cylindrical inner surface 34 and a cylindrical outer surface 35. The cylindrical inner surface 34 surrounds a cavity 36 that may receive at least a portion of adapter 4 as shown in FIG. 2. Base 2 may comprise a one-piece (e.g. welded) structure made from mild steel, stainless steel, or other suitable material. A plurality of bases 2 may be mounted to a wall 30 of a blast work area 32, and a plurality of different lances or nozzles 15 may be attached to a plurality of adapters 4, and the adapters 4 and tools 15 may be supported on the bases 2. A robotic arm 7 and hose coupler 3 may pick up and drop off the lances or nozzles 15 from the different bases 2 to thereby permit tool changes for different blasting operations. For example, a part to be blasted may have outer surfaces that need to be blasted by a specific nozzle, and the same part may have bores or cavities that require use of a specific lance to perform the blasting operations on a surface of the bore or cavity. In general, nozzles may be configured to direct the solid media and air or other material in an axial direction “A1” and lances may be configured to direct the solid media and air or other material in a transverse direction “A2.” Each nozzle and/or lance 15 can be connected to an adapter 4 and supported by a base 2 whereby the robot arm 7 can change tools 15 as required for the different operations.

With further reference to FIGS. 4-6, hose 13 may be positioned in internal cavity 10 of hose coupler 3 and fasteners such as screws 37 may be driven into hose 13 (see also FIG. 1) to secure the hose 13 in place. In general, hose 13 may comprise rubber or other resilient material of a known type. Internal passageway 10 of hose coupler 3 may include a cylindrical first portion 39 having a diameter that is about the same as an outer diameter of the hose 13 to permit the hose 13 to slide into the portion 39 of cavity 10. Passageway 10 further includes a portion 40 having an inner diameter that is somewhat larger than the inner diameter of portion 39. The portion 40 also defines a cavity 41. Portion 40 of passageway 10 of hose coupler 3 may have a cylindrical inner surface that closely receives end portion 42 of adapter 4 (e.g. FIG. 3). For example, end portion 42 of adapter 4 may have a cylindrical outer surface 43 having a diameter that is slightly less than a diameter of an inner cylindrical surface 44 of hose coupler 3 such that the position of adapter 4 and tool 15 relative to robot arm 7 is accurately maintained whereby the position of robot arm 7 can be accurately controlled to accurately control the position of tool 15 during blasting operations.

The hose coupler 3 may optionally include an opening 45 that closely receives a dowel pin 46. Dowel pin 46 may be received in corresponding opening 46A of bracket 8 (FIG. 6) to thereby locate the hose coupler 3 relative to bracket 8 and robot arm 7 to ensure that the position of a lance or nozzle 15 is known whereby the robot can be programmed to move various lances or nozzles to specific locations and/or along specific paths as required for a particular application.

Referring to FIG. 5, L-shaped slots 9 may include a first portion 47 having an open end 49 at lower edge 50 of hose coupler 3. L-shaped slots 9 may further include a second portion 48 that extends transverse relative to the first portion 47. L-shaped slots 9 may optionally further include a tapered (e.g. convex) edge portion 51, and a seating portion 52. In use, the first pins 19 initially enter tapered open end 49 of L-shaped slots 9, and translate along a centerline 47A of first portion 47 of L-shaped slots 9 in a direction opposite to arrow “P6.” When the pins 19 are at or adjacent a point 53A formed by the intersection of centerline 53 of second portion 48 and centerline 47A of first portion 47, the robot arm 7 rotates the hose coupler 3, whereby the pins 19 move towards an end 54 of second portion 48 of L-shaped slots 9. A resilient gasket 5 positioned at end 17 of adapter 4 (FIG. 1) contacts end edge 55 and/or annular step surface 56 of hose coupler 3 (FIG. 4), thereby creating a biasing force tending to push adapter 4 away from hose coupler 3 as gasket 5 is compressed. Pins 19 may slide along a cam surface formed by tapered or convex edge 51 (FIG. 5) of L-shaped slots 9 as the hose coupler 3 is rotated relative to adapter 4. Movement of pins 19 along cam or edge 51 creates an axial force that pulls hose coupler 3 and adapter 4 together to thereby compress the gasket 5 and form a seal. First pins 19 may travel along a curved path 53B as pins 19 slide along tapered edge 51.

When the pins 19 reach the end portion 54 of second portion 48 of L-shaped slots 9, compression of gasket 5 results in a force that biases the pins 19 in the direction of arrow “B” into engagement with seating surface 52. The seating surface 52 may comprise a recess or concave surface to thereby form a secure connection between hose coupler 3 and adapter 4 to prevent inadvertent dislodgement of adapter 4 from hose coupler 3. Specifically, the bias of gasket 5 urging pins into the seating portion 52 may create a detent force that must be overcome to rotate hose coupler 3 relative to adapter 4 to move the pins 19 in the direction P4 away from end portion 54. Thus, pins 19 are locked or retained in seating portion 52, and a significant torque must be applied to hose coupler 3 and adapter 4 to rotate coupler 3 relative to adapter 4 to move pins 19 in the direction P4 (FIG. 5) as required to align pins 19 with first portion 47 of L-shaped slots 9 when decoupling adapter 4 from hose coupler 3.

With further reference to FIGS. 7-9, adapter 4 includes a body 58. The body 58 may comprise mild steel, stainless steel, or other suitable material. The adapter 4 may further include an optional insert 59 that may be formed from an abrasion-resistant material such as boron carbide, tungsten carbide or other suitable material. For example, if the air and solid media utilized for a particular blasting operation comprises grit (e.g. aluminum oxide), the insert 59 may comprise boron carbide. However, if the media comprises shot (e.g. round metal, glass, ceramic, etc.) for shot peening operations, the insert 59 may comprise tungsten carbide. It will be understood that the solid media may also comprise relatively soft polymer particles or spheres, and insert 59 may not be required.

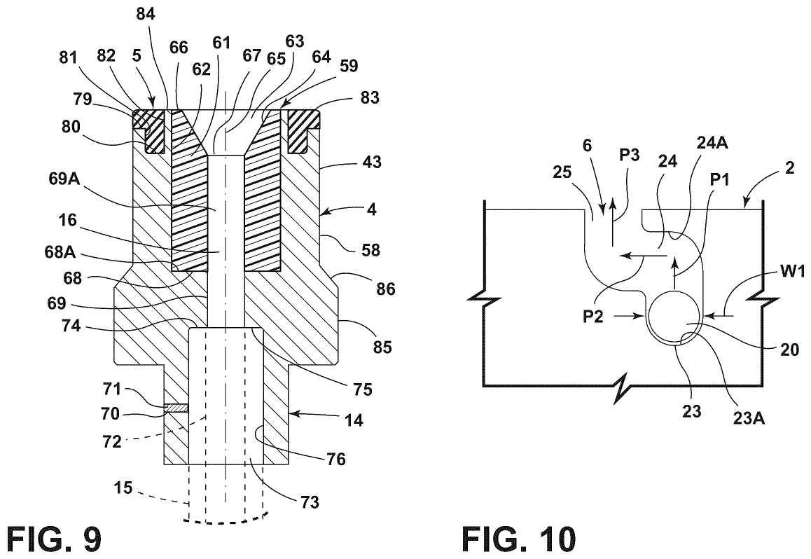

Insert 59 may have a cylindrical outer surface that is closely received in a cavity 61 (FIG. 9) of adapter 4. Cavity 61 may have a cylindrical inner surface 62 and an annular step 68A that are formed in body 58 of adapter 4. The insert 59 may be retained in cavity 61 by a press fit, adhesive (e.g. epoxy) or other suitable retaining techniques or materials. The insert 59 includes a funnel 63 comprising a tapered or conical surface 64 forming a larger opening 65 at outer end 66 of insert 59. Funnel 63 has a smaller diameter portion 67 that transitions to a cylindrical portion 69A of central portion 69 of adapter 4. The diameter of the funnel 63 at 67 is preferably about the same as the diameter of central portion 69 of internal passageway 16 of adapter 4.

Adapter 4 includes a connecting structure 14, which may include an end portion 73 of internal passageway 16 of adapter 4, and a threaded opening 70 which may be configured to receive a set screw 71 (FIG. 1). Set screw 71 bears against an end 72 (FIG. 9) of a lance or nozzle tool 15 in end portion 73 of internal passageway 16 of adapter 4 to retain tool 15. The end 74 of tool 15 may bear against annular step surface 75 at a transition between central portion 69 of internal passageway 16 and end portion 73 of internal passageway 16. A cylindrical inner surface 76 of end portion 73 of internal passageway 16 may have a diameter that is about the same or slightly larger than a diameter of end portion 72 of tool 15 whereby the tool 15 can be positioned accurately relative to adapter 4.

Referring again to FIGS. 7 and 8, pins 19 may be closely received in openings 77, and pins 20 may be closely received (e.g. press fit) in openings 78. The pins 19 and 20 may be spaced at equal angles ϕ of 120°. However, it will be understood that the pins 19 and 20 may be positioned at non-equal angles relative to one another in virtually any configuration. Threaded opening 70 may be at an angle ϕ relative to a pin 20. Angle ϕ may be about 15°. However, ϕ may comprise virtually any angle. Also, as shown, the adapter 4 may include three first pins 19 and three second pins 20. Alternatively, any number of pins 19 and 20 may be utilized. It will be understood that the number of slots 9 of hose coupler 3 generally corresponds to the number of pins 19, and the number of Z-shaped slots 6 of base 2 generally corresponds to the number of pins 20.

Referring again to FIGS. 7 and 9, gasket 5 may be positioned in an annular groove 79 at end 17 of adapter 4. The annular groove 79 may be formed by an annular base surface 80, a side surface 81 formed in body 58, and a side surface 82 comprising a portion of the cylindrical outer surface 60 of insert 59. As discussed above, gasket 5 is compressed when adapter 4 is coupled to hose coupler 3 due to engagement of pins 19 with edges 51 and/or 52 of L-shaped slots 9 (FIG. 5). When adapter 4 is coupled to hose coupler 3, surface 83 of gasket 5 may engage annular step surface 56 (FIG. 4) of internal passageway 10 of hose coupler 3 and/or end 55 of hose 13 to compress gasket 5.

Referring again to FIGS. 7 and 9, adapter 4 may include cylindrical outer surfaces 43 and 85, wherein cylindrical surface 85 has a diameter that is larger than the diameter of cylindrical surface 43. A tapered (e.g. conical) surface 86 extends between the cylindrical surfaces 43 and 85. Tapered surfaced 86 is configured such that grit or other particles slide off surface 86 to avoid a buildup on the surface. Cylindrical surface 85 has a diameter that is about the same or less than cylindrical inner surface 34 (FIG. 1) of base 2, whereby at least a portion of cylindrical outer surface 85 of adapter 4 may be closely received in cavity 36 of base 2 to thereby accurately position adapter 4 on base 2.

With further reference to FIG. 10, adapter 4 can be positioned on base 2 (see also FIG. 2), with pins 20 engaging end portions 23 of Z-shaped slots 6. As discussed above, end portions 23 of Z-shaped slots 6 have a width W1 that is slightly greater than a diameter of pins 20 to accurately position pins 20 such that adapter 4 is accurately located relative to base 2. This enables the robot to return to this location at a later time to retrieve the adapter 4. Thus, pins 20 support the adapter 4 and a tool 15 on the base 2 at a known location. As noted above, a plurality of the bases 2 may be positioned in a work area, and a plurality of adapters 4 and tools 15 may be positioned on the bases 2 in a work area. In general, the tool 15 may comprise a nozzle, lance, or other tool as required for a particular application. As discussed above, the hose coupler 3 may be coupled to adapter 4 by moving hose coupler 3 to position pins 19 of adapter 4 in end portions of L-shaped slots 9. The robot arm 7 can then be actuated to shift the adapter 4 and pins 20 vertically in the direction of the arrow “P1” as shown in FIG. 10. The robot arm 7 can then be actuated to rotate the hose coupler 3 and adapter 4 to move the pins 20 as shown by the arrow “P2,” followed by movement of pins 20 in the direction of the arrow “P3” to thereby disengage the adapter 4 from the base 2.

An adapter 4 and tool 15 can be decoupled from hose coupler 3 by reversing the operations used to couple adapter 4 to hose coupler 3. Specifically, to “drop off” an adapter 4 that is coupled to hose coupler 3, the robot arm 7 can be actuated to position the hose coupler 3 and adapter 4 above base 2 as shown in FIG. 3. The robot arm 7 can then be actuated to shift the adapter 4 and pins 20 downwardly into open ends 25 of Z-shaped slots 6 in a direction opposite arrow P3 (FIG. 10), followed by rotation in a direction that is opposite arrow P2. This may then be followed by downward translation of adapter 4 so that pins 20 move in a direction opposite arrow P1 until the pins 20 are positioned in the ends 23 of Z-shaped slots 6. The robot arm 7 can then be rotated to shift pins 19 in the direction of the arrow P4 (FIG. 5). As discussed above, gasket 5 biases pins 19 into concave (recessed) seating portions 52, and a rotational force (torque) is required to move pins 19 in the direction of arrow P4. Due to the curve of seating portion 52, pins 19 may initially move in a direction shown by the arrow “P4A” as pins 19 move along concave surface 52. Because a component of direction P4A is axial, this movement initially pulls hose coupler 3 and adapter 4 closer together and further compresses gasket 5. As pins 19 move along convex (tapered) surface 53, pins 19 travel along a curved path 53B and transition to movement in the direction of arrow P6, thereby decompressing gasket 5. More specifically, upward movement of hose coupler 3 causes pins 19 to travel in the direction of the arrow P6 (FIG. 5) relative to hose coupler 3, until the pins 19 exit the open end 49 of L-shaped slots 9.

If adapter 4 binds to hose coupler 3 (e.g. due to grit or the like disposed in the joint), an upward force may need to be applied to hose coupler 3 when pins 19 are aligned with first portions 47 of L-shaped slots 9. As hose coupler 3 and adapter 4 move upwardly, pins 20 (FIG. 10) move upwardly in the direction of arrow P1 until pins 20 contact surface 24A of transverse portion 24 of Z-shaped slots 6. This contact prevents further upward movement of adapter 4 relative to base 2 such that further upward movement of hose coupler 3 completely disconnects (decouples) hose coupler 3 from adapter 4. Adapter 4 may then drop down (e.g. due to gravity) whereby pins 20 engage end surface 23A to support adapter 4.

It will be understood that slots 6 could have a variety of shapes, and the term “Z-shaped” is not intended to limit slots 6 to a specific shape. Typically, slots 6 may include two upright portions that generally extend parallel to one another, and a transverse portion extending between and interconnecting the two upright portions. For example, slots 6 could be U-shaped whereby the upright portions extend away from the transverse portion in the same direction. Similarly, slots 9 are not limited to an L-shape, and may have virtually any suitable shape. Typically, slots 9 may have an upright portion and portion that is transverse to the upright portion.

The tool coupler 1 provides a secured, sealed connection between hose coupler 3 and adapter 4 to prevent solid media and air from escaping at the junction of hose coupler 3 and adapter 4 during operation. The blasting device may be configured to separately control the supply of air and solid media through hose 13. Thus, prior to picking up an adapter 4, the hose coupler 3 may be positioned directly above adapter 4 (e.g. FIG. 2), and air only (i.e. without solid media) may be supplied to hose 13 to thereby blow any dust, grit, or the like off the gasket 5 and/or upper end 17 of adapter 4 prior to coupling hose coupler 3 to adapter 4.

As discussed above, actuation of robot arm 7 may be utilized to couple and decouple hose coupler 3 and adapter 4, and also couple and decouple adapter 4 to base 2. Thus, human/manual operations are not required to change tools 15. Furthermore, the robot arm 7 itself is utilized to provide the coupling and decoupling described above, such that a separate powered actuator is also not required to provide for changes of tools 15.

The tool changer 1 of the present disclosure is also adapted to be used in harsh environments that may include dust, grit, or the like that might otherwise interfere with tool changing operations. In general, the surface 86 of adapter 4 may be tapered as described above to shed grit or other matter that might otherwise accumulate on adapter 4 when the adapter 4 is positioned in a base 2 while a different adapter 4 and tool 15 are being used by the robot to perform blasting operations.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents. CLAIM(S)

The invention claimed is:

1. A tool changer for robotic systems, the tool changer comprising:
a base having a plurality of Z-shaped slots;
a hose coupler that is configured to be mounted to a robot arm, the hose coupler including a plurality of L-shaped slots and an internal passageway that is open at opposite ends of the hose coupler whereby the hose coupler can be coupled to a hose to permit solid media and gas and/or other matter from the hose to pass through the internal passageway of the hose coupler;
an adapter having a connecting structure that permits a tool to be secured to the adapter, the adapter further including an internal passageway that is open at opposite ends of the adapter, and a first set of pins that are configured to releasably engage the L-shaped slots of the hose coupler to couple the adapter to the hose coupler whereby, in use, solid media and gas and/or other matter from the hose coupler can flow through the internal passageway of the adapter, the adapter further including a second set of pins that are configured to releasably engage the Z-shaped slots of the base, whereby in use the adapter can be positioned on the base with the second set of pins engaging the Z-shaped slots of the base, and the hose coupler can be attached to a robot arm whereby the hose coupler can be moved into engagement with the adapter such that the first set of pins of the adapter enter first portions of the L-shaped slots of the hose coupler followed by rotation of the hose coupler such that the first set of pins of the adapter move into second portions of the L-shaped slots of the hose coupler to attach the adapter to the hose coupler, and wherein the robot arm can then disengage the adapter from the base by shifting the adapter to move the second set of pins from end portions of the Z-shaped slots of the base, followed by rotation of the adapter to move the second set of pins in transverse portions of the Z-shaped slots of the base, followed by shifting the adapter to move the second set of pins out of open end portions of the Z-shaped slots of the base.

2. The tool changer of claim 1, wherein:
the base includes a sidewall extending around a cavity, and the Z-shaped slots are formed in the sidewall.

3. The tool changer of claim 2, wherein:
the sidewall includes an upper edge, and the open end portions of the Z-shaped slots form gaps in the upper edge whereby the Z-shaped slots open upwardly.

4. The tool changer of claim 3, wherein:
the transverse portions of the Z-shaped slots are orthogonal to 1) the open end portions of the Z-shaped slots, and 2) the end portions of the Z-shaped slots whereby the adapter can remain coupled to the base while the hose coupler is decoupled from the adapter by aligning the first set of pins with the first portions of the L-shaped slots of the hose coupler and shifting the hose coupler away from the adapter such that the second set of pins engage the transverse portions of the Z-shaped slots to prevent decoupling of the adapter from the base as the hose coupler is decoupled from the adapter.

5. The tool changer of claim 4, wherein:
the adapter defines an axis, and the first set of pins extend radially outward from the axis.

6. The tool changer of claim 5, wherein:
the first set of pins comprises at least three pins that are orthogonal to the axis of the adapter, and wherein the at least three pins are positioned at equal angles relative to each other.

7. The tool changer of claim 3, including:
a gasket engaging the hose coupler and the adapter to form a seal and provide a compressive force to assist in retaining the adapter to the hose coupler.

8. The tool changer of claim 7, wherein:
the hose coupler has first and second opposite ends, and the L-shaped slots are on the first end of the hose coupler, the hose coupler having a bore extending between the first and second opposite ends, the bore including an annular step surface facing the first end of the hose coupler;
the adapter has first and second opposite ends, the first end including an annular seal surface;
the gasket includes opposite sides that contact the annular step surface of the hose coupler and the annular seal surface of the adapter to form a seal that is configured to prevent escape of gas and/or solid media and/or other matter from the internal passageways of the hose coupler and the adapter.

9. The tool changer of claim 8, wherein:
the annular seal surface comprises an annular grove having a base surface and opposite side surfaces that are transverse to the base surface, and wherein at least a portion of the gasket is disposed in the annular groove.

10. The tool changer of claim 9, wherein:
the internal passageway of the adapter includes a central portion and tapered funnel surface at the first end of the adapter that is configured to funnel incoming solid media and gas and/or other matter into the central portion of the passageway.

11. The tool changer of claim 10, wherein:
the adapter includes a body comprising a first material and an abrasion resistant insert comprising a second material that is harder than the first material, and wherein the tapered funnel surface is formed on the abrasion resistant insert.

12. The tool changer of claim 11, wherein:
the abrasion resistant insert is disposed in a cavity at the first end of the adapter, the abrasion resistant insert including a cylindrical outer surface, a portion of the cylindrical outer surface defining an opposite side surface of the annular groove of the adapter.

13. The tool changer of claim 12, wherein:
the internal passageway of the adapter includes an enlarged nozzle-receiving portion at the second end of the adapter that is configured to receive a portion of a nozzle or a lance whereby, in use, solid media and gas and/or other matter can flow from the internal passageway of the adapter into the nozzle or lance.

14. The tool changer of claim 13, wherein:
the sidewall of the base includes a cylindrical inner surface forming an upwardly-opening cavity.

15. The tool changer of claim 14, wherein:
the first set of pins of the adapter extend outwardly from a cylindrical first outer surface of the adapter, and the second set of pins of the adapter extend outwardly from a cylindrical second outer surface of the adapter, and wherein the cylindrical first outer surface of the adapter has a smaller diameter than the cylindrical second outer surface of the adapter, and the cylindrical second outer surface of the adapter has a diameter that is less than a diameter of the cylindrical inner surface of the sidewall of the base whereby the cylindrical second outer surface of the adapter fits in the cavity of the base;
the passageway of the hose coupler includes an upper portion that is configured to receive an end of the hose, and a lower portion that is configured to closely receive the first end of the adapter whereby at least a portion of the cylindrical first outer surface of the adapter is disposed in the lower portion of the passageway of the hose coupler when the adapter is coupled to the hose coupler.

16. The tool changer of claim 7, wherein:
the L-shaped slots of the hose coupler include tapered edge portions that slidably engage the first set of pins and draw the adapter towards the hose coupler as the hose coupler is rotated relative to the adapter to thereby compress the gasket.

17. The tool changer of claim 16, wherein:
the L-shaped slots of the hose coupler include first portions having open ends to receive the first set of pins of the adapter, and second portions that are transverse to the first portions.

18. The tool changer of claim 17, wherein:
the second portions of the L-shaped slots include a seating surface and the first set of pins engage the seating surfaces when the adapter is coupled to the hose coupler and wherein compression of the gasket biases the first set of pins into engagement with the seating surfaces and the seating surfaces provide detent forces that must be overcome to move the first set of pins out of engagement with the seating surfaces.

19. The tool changer of claim 18, wherein:
the seating surfaces comprise concave surfaces.

20. The tool changer of claim 19, wherein:
the tapered edge portions of the L-shaped slots comprise convex edge surfaces extending between the first and second portions of the L-shaped slots.

21. A tool changer for robotic systems, the tool changer comprising:
a base having a first connecting structure;
a hose coupler that is configured to be mounted to a robot arm, the hose coupler including a second connecting structure;
an adapter that is configured to have a tool secured thereto, the adapter including a third connecting structure that is configured to releasably engage the second connecting structure of the hose coupler to releasably couple the adapter to the hose coupler, the adapter further including a fourth connecting structure that is configured to engage the first connecting structure of the base, whereby in use the adapter can be supported by the base with the fourth connecting structure engaging the first connecting structure of the base, and the hose coupler can be attached to a robot arm whereby the hose coupler can be moved into engagement with the adapter such that the third connecting structure of the adapter engages the second connecting structure of the hose coupler whereby the adapter is coupled to the hose coupler due to movement of the hose coupler relative to the adapter, and wherein the robot arm can then decouple the adapter from the base by moving the adapter to disengage the fourth connecting structure from the first connecting structure whereby the adapter can be moved away from the base.

22. The tool changer of claim 21, wherein:
the first connecting structure comprises one or more slots.

23. The tool changer of claim 22, wherein:
the one or more slots have an upwardly extending portion having an open end.

24. The tool changer of claim 23, wherein:
the one or more slots include at least one transverse portion that is transverse to the upwardly extending portion.

25. The tool changer of claim 24, wherein:
the upwardly extending portion comprises a first upwardly extending portion;
the one or more slots include a second upwardly extending portion.

26. The tool changer of claim 25, wherein:
the first upwardly extending portion and the second upwardly extending portion are horizontally offset relative to one another.

27. The tool changer of claim 26, wherein:
the second upwardly extending portion extends downwardly from the transverse portion.

28. The tool changer of claim 27, wherein:
the first upwardly extending portion, the transverse portion, and the second upwardly extending portion form a Z-shaped slot.

29. The tool changer of claim 21, wherein:
the second connecting structure comprises one or more slots in the hose coupler.

30. The tool changer of claim 29, wherein:
the one or more slots in the hose coupler have an upwardly extending portion having an open end.

31. The tool changer of claim 30, wherein:
the one or more slots include at least one transverse portion that is transverse to the upwardly extending portion.

32. The tool changer of claim 31, wherein:
the one or more slots in the hose coupler are L-shaped.

33. The tool changer of claim 21, wherein:
the third connecting structure of the adapter comprises a first set of pins that are adapted to releasably engage the second connecting structure of the hose coupler.

34. The tool changer of claim 21, wherein:
the fourth connecting structure of the adapter comprises a second set of pins that are adapted to releasably engage the first connecting structure of the base.

35. The tool changer of claim 21, wherein:
the hose coupler includes an internal passageway that is open at opposite ends of the hose coupler whereby the hose coupler can be coupled to a hose to permit solid media and fluid and/or other matter from the hose to pass through the internal passageway of the hose coupler.

36. The tool changer of claim 35, wherein:
the adapter includes an internal passageway that is open at opposite ends of the adapter whereby solid media and fluid and/or other matter from the hose coupler can flow through the internal passageway of the adapter to a nozzle or lance that is mounted to the adapter.

37. The tool changer of claim 21, wherein:
the second connecting structure of the hose coupler can be moved into engagement with the third connecting structure of the adapter by initially moving the hose coupler towards the adapter, followed by rotation of the hose coupler relative to the adapter to thereby couple the hose coupler to the adapter.

38. The tool changer of claim 37, wherein:
after coupling the hose coupler to the adapter, the adapter can be decoupled from the base by shifting the adapter relative to the base a first time, followed by rotating the adapter relative to the base, followed by shifting the adapter relative to the base a second time.

39. The tool changer of claim 38, wherein:
initially moving the hose coupler towards the base includes moving the hose coupler downwardly relative to the adapter.

40. The tool changer of claim 39, wherein:
shifting the adapter relative to the base a first time includes moving the adapter upwardly relative to the base.

41. The tool changer of claim 40, wherein:
shifting the adapter relative to the base a second time includes moving the adapter upwardly relative to the base.

42. The tool changer of claim 21, wherein:
the first connecting structure of the base comprises a plurality of upwardly opening Z-shaped slots;
the second connecting structure of the hose coupler comprises a plurality of L-shaped slots;
the third connecting structure of the adapter comprises a first set of pins;
the fourth connecting structure of the adapter comprises a second set of pins.

43. The tool changer of claim 21, wherein:
movement of the third connecting structure relative to the second connecting structure causes movement of the hose coupler towards the adapter such that a resilient member is compressed whereby a biasing force of the resilient member biases the third connecting structure into engagement with a retaining feature of the second connecting structure such that a force sufficient to overcome the biasing force is required to disengage the third connecting structure from the retaining feature.

44. The tool changer of claim 41, wherein:
the resilient member comprises a gasket that is positioned between a sealing surface of the hose coupler and a sealing surface of the adapter whereby the gasket seals a passageway extending through the hose coupler to a passageway extending through the adapter.

45. The tool changer of claim 21, wherein:
the fourth connecting structure engages the first connecting structure and holds the adapter relative to the base at a repeatable location when the hose coupler is decoupled from the adapter.

46. The tool holder of claim 21, wherein:
the fourth connecting structure engages the first connecting structure and prevents rotation of the adapter relative to the base as the second connecting structure and the third connecting structure are coupled and/or decoupled by movement of the second connecting structure relative to the third connecting structure.

47. The tool changer of claim 21, wherein:
engagement of the first connecting structure and the fourth connecting structure limits movement of the adapter relative to the base such that the hose coupler can be moved away from the adapter and decoupled from the adapter when the third connecting structure is moved to a release position relative to the second connecting structure, even if the adapter binds to the hose coupler such that a force greater than a weight of the adapter is required to decouple the adapter from the hose coupler.
